(19) United States
(12) Patent Application Publication
(10) Pub. No.: US 2026/0171549 A1
(43) Pub. Date: Jun. 18, 2026

(54) COOLANT SYSTEM FOR AN ELECTRIC VEHICLE

(71) Applicant: HELLA GmbH & Co. KGaA, Lippstadt (DE)

(72) Inventor: Sebastian TIEMEYER, Dortmund (DE)

(73) Assignee: HELLA GmbH & Co. KGaA, Lippstadt (DE)

(21) Appl. No.: 19/534,026

(22) Filed: Feb. 9, 2026

Related U.S. Application Data
(63) Continuation of application No. PCT/EP2024/071883, filed on Aug. 1, 2024.

(30) Foreign Application Priority Data
Aug. 9, 2023 (DE) 10 2023 121 245.1

(51) Int. Cl. H01M 10/6568; H01M 10/613; H01M 10/625

(52) U.S. Cl. CPC H01M 10/6568; H01M 10/613; H01M 10/625; H01M 2220/20

(57) ABSTRACT

A coolant system for an electric vehicle for circulating a coolant, comprising a multiplicity of components through which the coolant can flow and can be connected to one another in terms of coolant flow via at least one valve and coolant lines. The multiplicity of components are arranged in a distributed manner in at least two coolant circuits of the coolant system that can be connected and disconnected by the at least one valve. A single expansion tank is arranged in only one of the coolant circuits. The coolant system is designed such that this coolant circuit is disconnected fluidically from at least one other coolant circuit of the at least two coolant circuits by the at least one valve, at least in one operating state of the coolant system, and, in this operating state, this other coolant circuit can be connected to the coolant circuit having the expansion tank.

This nonprovisional application is a continuation of International Application No. PCT/EP 2024/071883, which was filed on Aug. 1, 2024, and which claims priority to German Patent Application No. 10 2023 121 245.1, which was filed in Germany on Aug. 9, 2023, and which are both herein incorporated by reference.

### BACKGROUND OF THE INVENTION

### Field of the Invention

The present invention relates to a coolant system for an electric vehicle.

### Description of the Background Art

Coolant systems for electric vehicles are already known from the prior art in numerous examples.

This is the starting point for the present invention.

### SUMMARY OF THE INVENTION

It is therefore an object of the present invention to improve a coolant system for an electric vehicle.

This object is attained, in an example, by a coolant system for electric vehicles, which is characterized in that only a single expansion tank of the coolant system is arranged in only one of the coolant circuits, wherein the coolant system is designed such that this coolant circuit is essentially disconnected fluidically from at least one other coolant circuit of the at least two coolant circuits by means of the at least one valve, at least in one operating state of the coolant system, and, in this operating state of the coolant system, this other coolant circuit can be connected or is connected to the coolant circuit having the expansion tank in essentially only a pressure-compensating manner by means of a pressure compensation device of the coolant system. The components of the coolant system in this case can each be designed as any practical and suitable component of the coolant system according to the invention through which the coolant can flow. The dependent claims relate to advantageous improvements of the invention.

An important advantage of the invention is, in particular, that a coolant system for an electric vehicle is improved. On account of the invention, functionally complex coolant systems for electric vehicles having an expansion tank can be implemented in a manner that is simpler in terms of design and manufacturing. By means of the design according to the invention of the coolant system, it is also possible in the case of at least one operating state of the coolant system according to the invention for which at least one of the at least two coolant circuits is essentially disconnected fluidically from the coolant circuit having the expansion tank to ensure a pressure compensation for all coolant circuits of the coolant system according to the invention with only a single expansion tank of the coolant system according to the invention by means of this expansion tank in the aforementioned operating state of the coolant system according to the invention, as well. Accordingly, it is not necessary to provide a multiplicity of expansion tanks arranged in different coolant circuits for the above-mentioned at least one operating state in order to make possible pressure compensation for each of the coolant circuits of the coolant system according to the invention in each of the fundamentally possible operating states of the coolant system according to the invention. Accordingly, the efficiency of such coolant systems is improved by means of the invention since the aforementioned systems make possible higher functional complexity with fewer components and coolant lines as compared with the prior art. Thus, a multiplicity of operating states, which is to say operating modes of the system, can be realized with a simply constructed coolant system according to the invention with few components and coolant lines. Furthermore, on account of the smaller number of components, the coolant system according to the invention can be implemented in a more compact, and thus more space saving, manner than comparable coolant systems in terms of function. In addition to its primary function for ensuring pressure compensation in the coolant system according to the invention, the only one expansion tank of the coolant system according to the invention in this case can, at the same time, be designed suitably for filling of the coolant in the coolant system according to the invention and also as a reservoir for the coolant filled in the coolant system according to the invention.

The cooling system according to the invention for an electric vehicle can be freely chosen within broad suitable limits in terms of type, mode of operation, material, and dimensioning. In addition, the invention is not restricted to an application with all-electric vehicles. For example, the invention can also be employed advantageously with so-called hybrid vehicles.

An advantageous improvement of the coolant system according to the

invention provides that the pressure compensation device can be designed such that, in the aforementioned operating state, in addition to the fluidic connections between the at least two coolant circuits by means of the pressure compensation device fundamentally made possible by means of the at least one valve, only a single additional pressure-compensating connection can be established or is established between the coolant circuit having the expansion tank and the coolant circuit disconnected from this coolant circuit in the aforementioned operating state. In this way, it is ensured in a manner that is very simple in terms of design, manufacturing, and switching that an unwanted circulation of the coolant between the coolant circuits that are essentially disconnected from one another in terms of flow in the aforementioned operating state does not occur on account of the pressure compensation device of the coolant system according to the invention.

Another advantageous improvement of the coolant system according to the invention provides that the pressure compensation device can be at least partially integrated into a valve of the at least one valve(s), wherein a valve body of this valve is arranged so as to be rotatable about a rotational axis of this valve in a valve housing of this valve having a multiplicity of valve housing openings of this valve, and wherein the valve housing openings are surrounded by a valve seal arranged between the valve housing and the valve body. As a result, the pressure compensation device, and the coolant system according to the invention equipped therewith, can be implemented in an especially simple manner in terms of design and manufacturing. This applies especially to the case in which the pressure compensation device, except for the requisite coolant lines, is arranged only in the at least one valve, preferably in only one of the at least one valve(s), especially preferably in only the at least one valve designed as a single valve, of the coolant system according to the invention.

An advantageous improvement of the aforementioned improvement of the coolant system according to the invention provides that the valve can have at least one recess in a circumferential surface of the valve body for the purpose of forming the pressure compensation device, wherein the valve housing, the valve seal, and the valve body of the valve are matched to one another in design such that all fluidic connections between the at least two coolant circuits that are fundamentally made possible by means of the valve and correspond to a totality of the fundamentally possible operating states of the coolant system can be realized in a functionally reliable manner. In this way, the pressure compensation device can be realized in the valve in an especially simple manner in terms of design and manufacturing without adversely affecting the function of the coolant system according to the invention, for example by an unwanted coolant circulation between the coolant circuits that are essentially disconnected in terms of flow by means of this valve in at least one of the operating states.

It is possible, for example, that the aforementioned valve can have two recesses in a circumferential surface of the valve body for the purpose of forming the pressure compensation device.

An advantageous improvement of the coolant system according to the invention provides, that the valve can also have at least one recess in the valve seal for the purpose of forming the pressure compensation device, wherein the valve housing, the valve seal, and the valve body of the valve are matched to one another in design such that all fluidic connections between the at least two coolant circuits that are fundamentally made possible by means of the valve and correspond to the totality of the fundamentally possible operating states of the coolant system can be realized in a functionally reliable manner. In this way, the construction of the aforementioned valve is simplified further. For example, provision can be made that only one recess in the valve body and only one recess in the valve seal are provided for the purpose of forming the pressure compensation device in this valve.

An advantageous improvement of the coolant system according to the invention provides that the recesses arranged in the valve body, or the recesses arranged in the valve body and in the valve seal, can be connected in a pressure-compensating manner by means of a pressure compensation connection formed between an inner side of the valve housing and an outer side of the valve body, preferably an end face of the valve body, in the operating state of the coolant system in which the at least one other coolant circuit is essentially disconnected fluidically from the coolant circuit having the expansion tank. In this way, the pressure-compensating connection between the aforementioned recesses in the valve that is necessary for pressure compensation by means of the expansion tank can be implemented in a manner that is especially simple in terms of design and manufacturing. Moreover, the invention has the further advantage that the distance between the aforementioned recesses in the valve is maximized so that an unwanted heat transfer is minimized between the coolant circuits that are disconnected per se.

The valve with the pressure compensation device at least partially integrated therein can be designed as a multiway valve with two levels arranged one above the other, wherein the multiplicity of the valve housing openings in the valve housing of this multiway valve are associated in some cases with the lower level, in some cases with the upper level, and in some cases with both levels, and wherein the valve body of this multiway valve, which is arranged in the valve housing so as to be rotatable about the rotational axis, has at least one valve passage associated in each case with at least one of the lower and upper levels and disconnected fluidically from one another. As a result, the number of valves and of coolant lines is substantially reduced in the coolant system according to the invention. It is possible, furthermore, that the aforementioned valve body also has, in addition to the at least one valve passage associated with the lower level and the at least one valve passage associated with the upper level, at least one valve passage that fluidically connects at least one valve housing opening associated with the lower level to at least one valve housing opening associated with the upper level in at least one operating state of the coolant system according to the invention.

The at least one recess in the valve body, or the at least one recess in the valve body and the at least one recess in the valve seal, can be designed and arranged such that the fluidic disconnection of the at least one valve passage of the lower level from the at least one valve passage of the upper level is ensured in all fluidic connections between the at least two coolant circuits that are fundamentally made possible by means of the multiway valve. In this way, it is ensured that the functionality of the coolant system according to the invention is provided in all fundamentally intended operating states of the coolant system according to the invention.

The coolant system can be designed such that, in the operating state of the coolant system in which the at least one other coolant circuit is essentially disconnected fluidically from the coolant circuit having the expansion tank, a back pressure acting in the coolant system by means of the pressure compensation device acts solely from the coolant circuit having the expansion tank on the at least one other coolant circuit. As a result, it is ensured that an inherently unwanted coolant flow in the direction of the expansion tank does not occur.

The at least two coolant circuits can be designed as a battery sub-circuit on the one hand and on the other hand as a drive train sub-circuit of an electric vehicle. For electric vehicles, demand-based temperature control is necessary, in particular of the drive train of the electric vehicle, which is to say power electronics and an electric motor of the electric vehicle for driving the same, and the battery of the electric vehicle, which is to say a battery of the electric vehicle that supplies the aforementioned electric motor with electric power. Accordingly, the coolant system according to the invention can be employed to particular advantage in this application of the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is an example of a cooling system with the coolant system according to the invention in a process flow diagram,

FIG. 2 is the example in an analogous representation to FIG. 1, in a first operating state of the coolant system,

FIG. 3 is the example in an analogous representation to FIG. 1, in a second operating state of the coolant system,

FIG. 4 is the example in an analogous representation to FIG. 1, in a third operating state of the coolant system,

FIG. 5 is the example in an analogous representation to FIG. 1, in a fourth operating state of the coolant system,

FIG. 6 is the example in an analogous representation to FIG. 1, in a fifth operating state of the coolant system,

FIG. 7 is an example of a valve of the coolant system according to the invention in a perspective representation,

FIG. 8 is the valve in an analogous representation to FIG. 7, without the valve housing cover,

FIG. 9 is the valve in an analogous representation to FIG. 7, in a first cross section through the upper level of the valve,

FIG. 10 is the valve in an analogous representation to FIG. 7, in a second cross section through the lower level of the valve,

FIG. 11 is the valve in an analogous representation to FIG. 8 in the first operating state of the coolant system in accordance with FIG. 2, with flow arrows,

FIG. 12 is the valve in an analogous representation to FIG. 9 in the first operating state of the coolant system in accordance with FIG. 2, with flow arrows,

FIG. 13 is the valve in an analogous representation to FIG. 10 in the first operating state of the coolant system in accordance with FIG. 2, with flow arrows,

FIGS. 14a to 14c show the valve in three simplified and mutually corresponding cross-sectional representations in the first operating state of the coolant system in accordance with FIG. 2, whereby FIG. 14a is in a cross section above the upper level of the valve, FIG. 14b is in a cross section through the upper level of the valve, and FIG. 14c is in a cross section through the lower level of the valve,

FIGS. 15a to 15c is the valve in an analogous representation to FIG. 14a to 14c, in the second operating state of the coolant system in accordance with FIG. 3,

FIGS. 16a to 16c is the valve in an analogous representation to FIG. 14a to 14c, in the third operating state of the coolant system in accordance with FIG. 4,

FIGS. 17a to 17c is the valve in an analogous representation to FIG. 14a to 14c, in the fourth operating state of the coolant system in accordance with FIG. 5, and

FIGS. 18a to 18c is the valve in an analogous representation to FIG. 14a to 14c, in the fifth operating state of the coolant system in accordance with FIG. 6.

### DETAILED DESCRIPTION

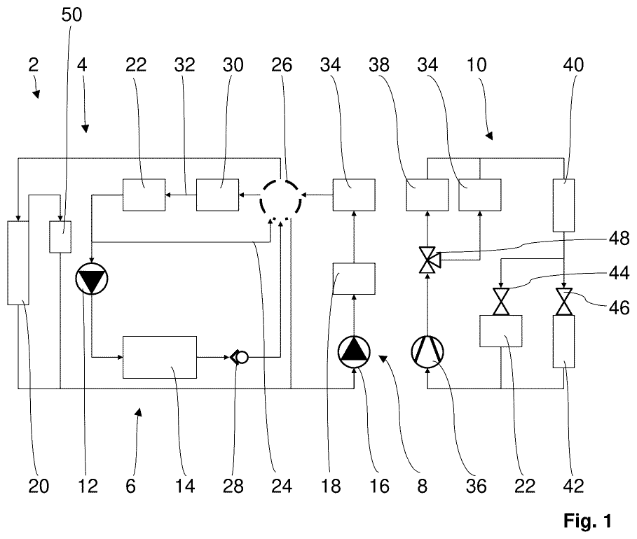

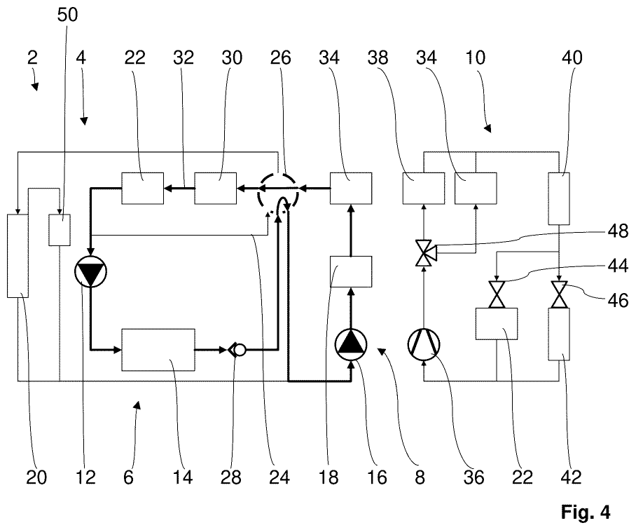

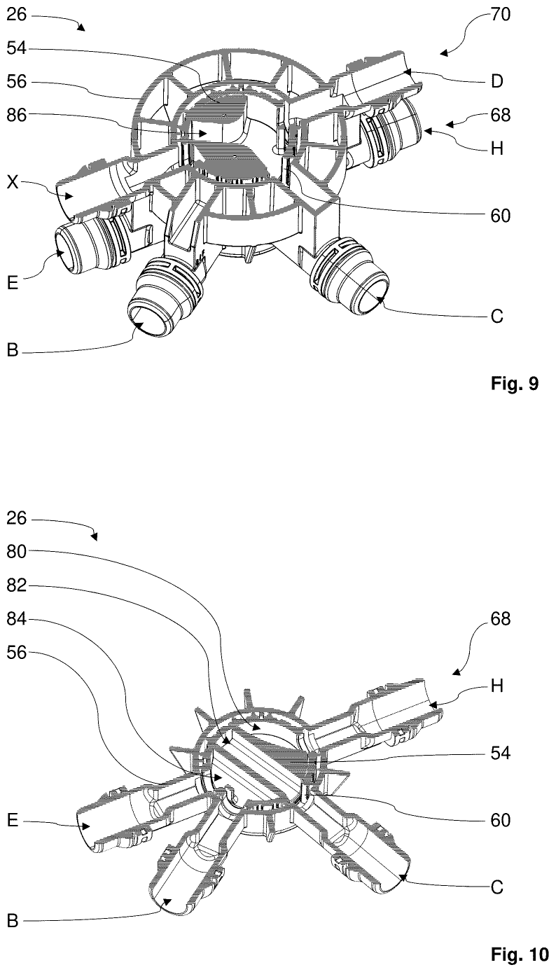

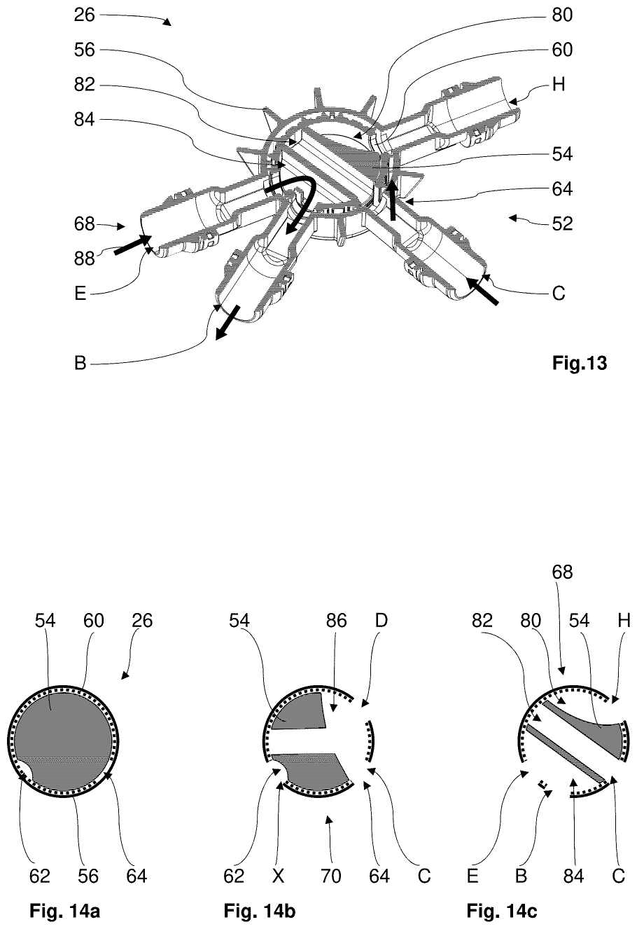

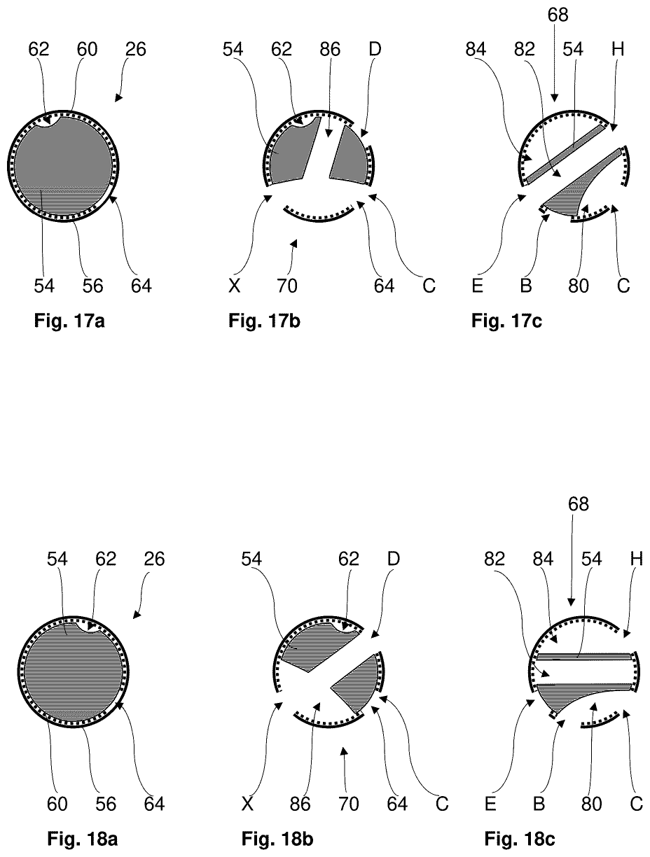

An example of a cooling system for an electric vehicle having the coolant system according to the invention for an electric vehicle is shown strictly by way of example in FIG. 1 to 18c.

The electric vehicle can be designed as an all-electric vehicle here.

The cooling system 2 for the electric vehicle includes, on the one hand, a coolant system 4 with a first coolant circuit 6 designed as a battery sub-circuit and a second coolant circuit 8 designed as a drive train sub-circuit, and on the other hand a refrigerant circuit 10 for air conditioning of a passenger compartment (not depicted) of the electric vehicle and for temperature control of the coolant system 4.

The coolant system 4 for circulating a liquid coolant includes, on the one hand, the battery sub-circuit 6 with the following components of the coolant system 4, namely a first coolant pump 12 and a battery 14, arranged downstream of the first coolant pump 12 in the direction of flow with respect to a flow of coolant through the first coolant pump 12, and, on the other hand, the drive train sub-circuit 8 with the following components of the coolant system 4, namely a second coolant pump 16 and a drive train 18 with power electronics and an electric motor, arranged downstream of the second coolant pump 16 in the direction of flow with respect to a flow of coolant through the second coolant pump 16, and a radiator 20 for cooling the coolant flowing in the drive train sub-circuit 8 with ambient air, wherein the battery sub-circuit 6 and the drive train sub-circuit 8 can be connected to one another in terms of coolant flow by means of at least one valve and coolant lines. The coolant is not depicted in FIG. 1 to 18c.

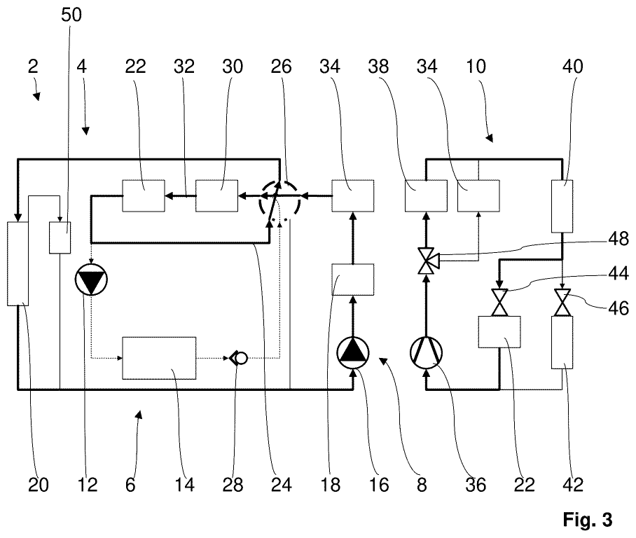

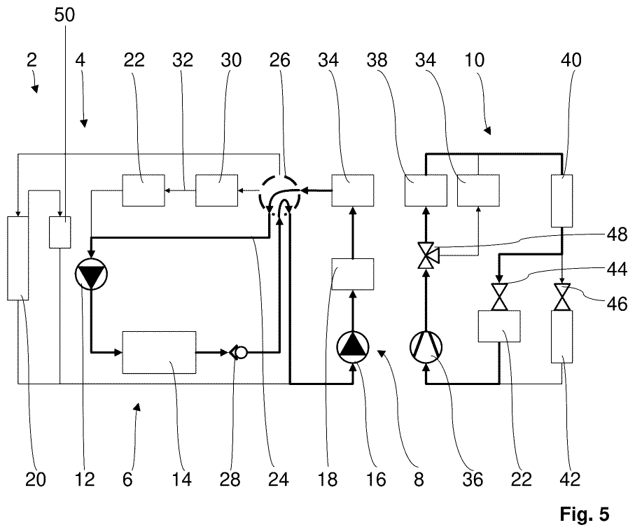

In addition, the coolant system 4 has at least one component 22 designed as a chiller and through which the coolant can flow, and a component bypass line 24 designed as a chiller bypass line. Furthermore, the at least one valve is designed as only a single multiway valve 26, wherein a component outlet of the chiller 22 designed as a chiller outlet can be connected to the multiway valve 26 in terms of coolant flow by means of the chiller bypass line 24 in such a manner that, in a first switching state of the multiway valve 26, coolant can flow through the chiller bypass line 24 in a first direction of flow as well as through the chiller 22, and in a second switching state of the multiway valve 26, coolant can flow through the chiller bypass line 24 in a second direction of flow opposite the first direction of flow, in a bypass of the chiller 22. In this regard see, for example, FIGS. 3 and 5, wherein the first switching state of the multiway valve 26 is shown in FIG. 3 and the second switching state of the multiway valve 26 in FIG. 5. The multiway valve 26 can be implemented in a variety of examples in terms of design and manufacturing that are suitable for the invention.

Consequently, the component 22 with the component outlet is designed as a chiller with a chiller outlet arranged in the battery sub-circuit 6, and the component bypass line 24 is designed as a chiller bypass line, wherein, in the second switching state of the multiway valve 26, the coolant can flow through the battery 14 by means of the chiller bypass line 24 in a bypass of the chiller 22. In terms of coolant flow with respect to a flow of coolant through the chiller 22 and the first coolant pump 12, one end of the chiller bypass line 24 here is arranged downstream of the chiller outlet and upstream of an inlet of the first coolant pump 12, wherein the battery 14 is arranged downstream of the first coolant pump 12 in the direction of flow with respect to a flow of coolant through the first coolant pump 12. Furthermore, in the battery sub-circuit 6 from FIG. 1 to 5, a check valve 28 is additionally arranged downstream of the battery 14 in the direction of flow with respect to a flow of coolant through the battery 14 in such a manner that the check valve 28 allows only a flow of the coolant from the battery 14 toward the multiway valve 26.

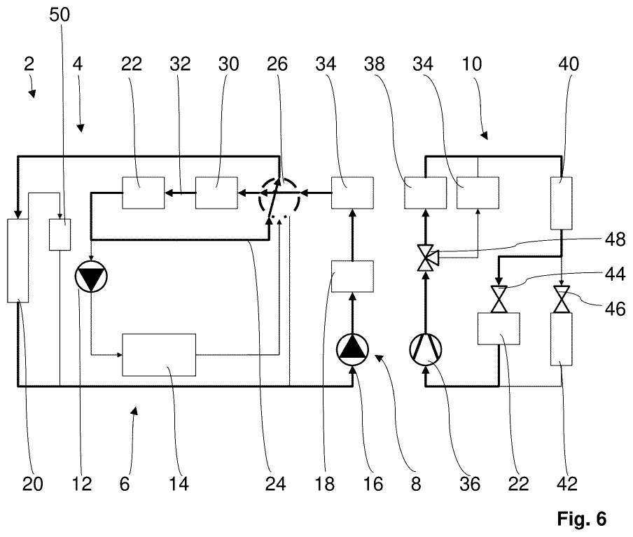

In contrast thereto, variants of the coolant system according to the invention, for example variants of the coolant system 4, are also possible in which the aforementioned use of a check valve can be dispensed with, however. In this regard see FIG. 6, for example, in which such a variant is shown strictly by way of example. In this variant from FIG. 6, which is to say when no check valve is provided, the aforementioned unwanted flow of coolant through the battery 14 is prevented by means of the multiway valve 26, which is to say in a switching state of the multiway valve 26.

In the example, the multiway valve 26 is designed such that coolant can flow without interruption through the drive train sub-circuit 8 in all possible switching states of the multiway valve 26 and when the multiway valve 26 transitions from one of these switching states into another of these switching states.

In the example, the battery sub-circuit 6 additionally has a coolant heater 30 designed as an electric heater for on-demand heating of the battery 14, wherein the coolant heater 30 is arranged downstream of the multiway valve 26 and upstream of the chiller 22 in the direction of flow with respect to a flow of coolant through the chiller 22, and wherein the chiller 22 and the coolant heater 30 are arranged in a common coolant line 32 of the battery sub-circuit 6.

As is evident from FIG. 1 to 6, on the one hand a heat transmission connection between the coolant system 4 on the one side and the refrigerant circuit 10 on the other side can be established on demand by means of the chiller 22. On the other hand, the refrigerant circuit 10 here has a condenser 34, wherein the cooling system 2 is designed such that a heat transmission connection between the coolant system 4 on the one side and the refrigerant circuit 10 on the other side can be established on demand by means of the condenser 34, alternatively or in addition to the chiller 22. For this purpose, the condenser 34 is arranged in the drive train sub-circuit 8 in terms of coolant flow.

The refrigerant circuit 10 also has the following further components in addition to the chiller 22 and the condenser 34: a compressor 36, another condenser 38, an accumulator 40, an evaporator 42, as well as two expansion valves 44, 46 and a switching valve 48. The said components of the refrigerant circuit 10 are connected to one another here in accordance with FIG. 1 to 6 and work together as a heat pump in the conventional manner for the purpose of air conditioning the passenger compartment of the electric vehicle.

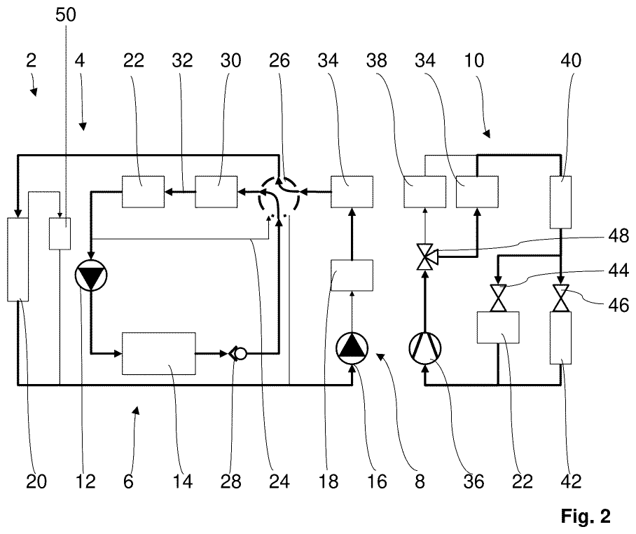

According to the invention, the coolant system 4 has only a single expansion tank 50 for the coolant system 4, which tank is arranged in only one of the coolant circuits 6, 8, namely in the drive train sub-circuit 8. The coolant system 4 is designed such that this coolant circuit 8 is essentially disconnected fluidically from at least one other coolant circuit 6, 8 of the at least two coolant circuits 6, 8, namely the battery sub-circuit 6, by means of the at least one valve, namely the multiway valve 26, at least in one operating state of the coolant system 4, and, in this operating state of the coolant system 4, this other coolant circuit 6 is connected to the coolant circuit 8 having the expansion tank 50 in essentially only a pressure-compensating manner by means of a pressure compensation device 52 of the coolant system 4. The aforementioned operating state is the first operating state in accordance with FIG. 2 here.

In the example, the pressure compensation device 52 is designed such that, in the aforementioned operating state, in addition to the fluidic connections between the coolant circuits 6, 8 by means of the pressure compensation device 52 fundamentally made possible by means of the multiway valve 26, only a single additional pressure-compensating connection is established between the coolant circuit 8 having the expansion tank 50 and the coolant circuit 6 disconnected from this coolant circuit 8 in the aforementioned operating state. The pressure compensation device 52 is at least partially integrated into the multiway valve 26, wherein a valve body 54 of this multiway valve 26 is arranged so as to be rotatable about a rotational axis 58 of this multiway valve 26 in a valve housing 56 of this multiway valve 26 having a multiplicity of valve housing openings B, C, D, E, H, X of this multiway valve 26, and wherein the valve housing openings B, C, D, E, H, X are surrounded by a valve seal 60 arranged between the valve housing 56 and the valve body 54.

The aforementioned valve housing openings B, C, D, E, H, X are connected fluidically to the coolant circuits 6, 8 from FIG. 1 to 6 as follows: The valve housing opening B corresponds to the coolant line fluidically connected to an inlet of the coolant heater 30, the valve housing opening C corresponds to the coolant line fluidically connected to an outlet of the condenser 34, the valve housing opening D corresponds to the coolant line fluidically connected to an inlet of the radiator 20 and to an inlet of the expansion tank 50, the valve housing opening E corresponds to the coolant line fluidically connected to an outlet of the battery 14, wherein the check valve 28 is additionally interposed between the outlet of the battery 14 and the valve housing opening E in accordance with FIG. 1 to 5, the valve housing opening H corresponds to the coolant line fluidically connected to an outlet of the radiator 20, to an outlet of the expansion tank 50, and to an inlet of the second coolant pump 16, and the valve housing opening X corresponds to the coolant line 24 fluidically connected to an inlet of the first coolant pump 12 and to the outlet of the chiller 22.

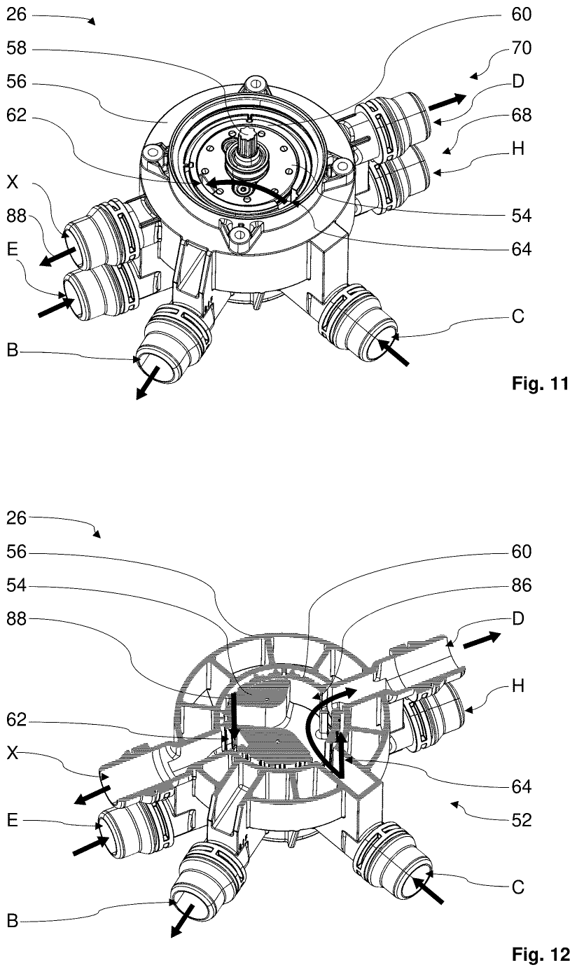

For the purpose of forming the pressure compensation device 52, the multiway valve 26 has a recess 62 in a circumferential surface of the valve body 54 and a recess 64 in the valve seal 60, wherein the valve housing 56, the valve seal 60, and the valve body 54 of the multiway valve 26 are matched to one another in design such that all fluidic connections between the at least two coolant circuits 6, 8 that are fundamentally made possible by means of the multiway valve 26 and correspond to a totality of the fundamentally possible operating states of the coolant system 4 can be realized in a functionally reliable manner. In the operating state of the coolant system 4 in which the coolant circuit 6 is essentially disconnected fluidically from the coolant circuit 8 having the expansion tank 50, the recess 62 arranged in the valve body 54 and the recess 64 arranged in the valve seal 60 are connected in a pressure-compensating manner by means of a pressure compensation connection formed between an inner side of the valve housing 56 and an outer side of the valve body 54, in particular an end face 66 of the valve body 54. In this regard, see FIG. 11 to 13, for example.

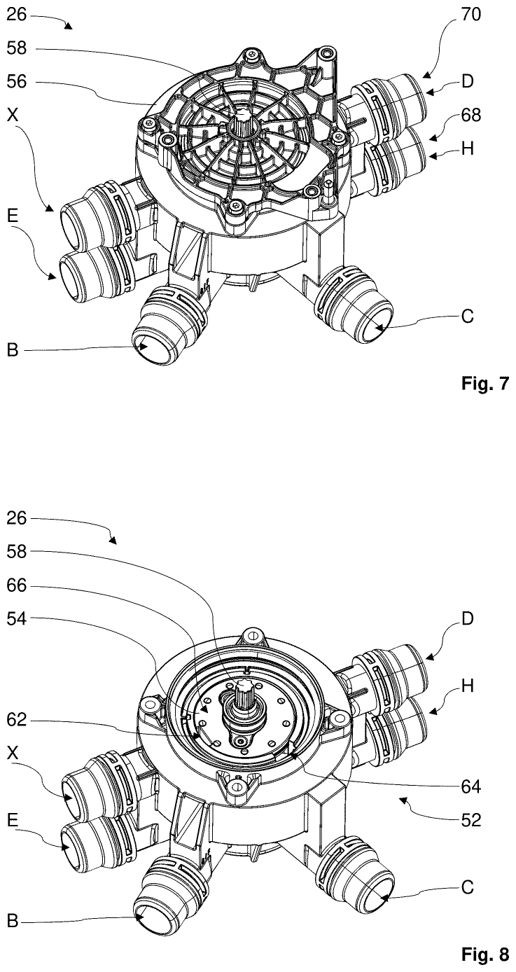

In FIG. 7 to 18c, the multiway valve 26 is shown in detail. As is evident from these figures, the multiway valve 26 with the pressure compensation device 52 at least partially integrated therein is designed as a multiway valve with two levels 68, 70 arranged one above the other, wherein the multiplicity of the valve housing openings B, C, D, E, H, X in the valve housing 56 of this multiway valve 26 are associated in some cases with the lower level 68, in some cases with the upper level 70, and in some cases with both levels 68, 70, and wherein the valve body 54 of this multiway valve 26, which is arranged in the valve housing 56 so as to be rotatable about the rotational axis 58, has valve passages 80, 82, 84, 86 associated in each case with at least one of the lower and upper levels 68, 70 and disconnected fluidically from one another. The valve housing openings B, E, H as well as the valve passages 80, 82, 84 are associated with the lower level 68, and the valve housing openings D and X as well as the valve passage 86 are associated with the upper level 70 of the multiway valve 26. The valve housing opening C is associated with both levels 68, 70. In the present example, the recess 62 in the valve body 54 and the recess 64 in the valve seal 60 are designed and arranged such that the fluidic disconnection of the at least one valve passage 80, 82, 84 of the lower level 68 level from the at least one valve passage 86 of the upper level 70 is ensured in all fluidic connections between the at least two coolant circuits 6, 8 that are fundamentally made possible by means of the multiway valve 26. Furthermore, the recess 62 in the valve body 54 in the upper level 70 is designed such that the recess 62 in the first operating state of the coolant system 4 makes possible a fluidic connection between the valve housing opening X and a space between the inner side of the valve housing 56 and the end face 66 of the valve body 54. The recess 62 here is designed as an indentation in the circumferential surface of the valve body 54, wherein the recess 62 does not extend into the lower level 68. For the purpose of forming the recess 64 in the valve seal 60, the valve seal 60 around the valve housing opening C is slotted to the end face 66 of the valve body 54 so that a fluidic connection is produced between the valve housing opening C and the space between the inner side of the valve housing 56 and the end face 66 of the valve body 54. Consequently, in the first operating state of the coolant system 4, the valve housing openings C and X are connected in a pressure-compensating manner in the aforementioned fashion. In the present example, the aforementioned pressure-compensating connection, by means of which the battery sub-circuit 6 is connected in a pressure-compensating manner to the expansion tank 50, is limited to the first operating state of the coolant system 4. This pressure compensation connection is not depicted in FIG. 2. Accordingly, this pressure-compensating connection is not present in the other operating states of the coolant system 4. Nor is this necessary, since the two coolant circuits 6, 8 are connected fluidically in these operating states. It is also possible in other example of the invention, however, that the aforementioned pressure compensation connection is also active in other operating states, which is to say in other operating modes. However, in this case the condition must be met that these operating states are not adversely affected by this pressure compensation connection.

The coolant system 4 here is designed in such a manner that, in the first operating state of the coolant system 4 in which the coolant circuit 6 is essentially disconnected fluidically from the coolant circuit 8 having the expansion tank 50, a back pressure acting in the coolant system 4 by means of the pressure compensation device 52, acts on the coolant circuit 6 solely from the coolant circuit 8 having the expansion tank 50.

The mode of operation of the cooling system with the coolant system according to the invention in accordance with the present example is explained in detail below on the basis of FIG. 1 to 18c.

Depending on the operating state of the cooling system 2, which is to say the battery sub-circuit 6, the drive train sub-circuit 8, and the refrigerant circuit 10, and also taking into account the driving situation and the ambient temperature, the aforementioned circuits can represent heat sources or heat sinks of the cooling system 2.

The efficiency of the system as a whole, which is to say of the cooling system 2, can be improved by a demand-based connecting or disconnecting of the individual aforementioned coolant circuits 6, 8. This takes place according to the invention in a manner that is especially simple in terms of design and manufacturing, with a simultaneous high efficiency of the system as a whole. The high flexibility with regard to the utilization of waste heat as well as the totality of the operating modes, which is to say operating states, of the cooling system 2 with the coolant system 4 according to the invention, would customarily, namely in the case of conventionally designed coolant systems, require a multiplicity of standard coolant valves to produce or disconnect the respective fluidic connections between the coolant circuits 6, 8, which would increase the system costs and the overall pressure loss, and thus simultaneously reduce system efficiency. In accordance with the present example, the structural system complexity is sharply reduced and the system efficiency is significantly improved.

The cooling system 2 with the coolant system 4 according to the invention makes possible the five operating states of the coolant system 4 that are evident from FIG. 2 to 6. The coolant lines of the coolant system 4 through which coolant flows in the respective operating state are drawn with heavy lines in the respective FIG. 2 to 6. The same applies to the refrigerant lines of the refrigerant system 10 through which refrigerant flows. FIG. 14a to 18c correspond in the above-mentioned manner to the five operating modes, which is to say operating states, depicted in FIG. 2 to 6. In addition, FIG. 7 to 13 correspond to the first operating state depicted in FIG. 2, in which the coolant circuit 8 having the expansion tank 50 is essentially disconnected in terms of flow from the coolant circuit 6 by means of the multiway valve 26.

In this first operating state of the coolant system 4 of the cooling system 2 and a switching state of the multiway valve 26 corresponding thereto, the battery 14 is cooled separately by the chiller 22, while the drive train 18 is connected to the radiator 20 in a coolant circuit parallel thereto. See FIG. 2 in this regard. As already explained above, the coolant circuit 6, designed as a battery sub-circuit, is essentially disconnected in terms of flow from the coolant circuit 8, designed as a drive train sub-circuit, by means of the multiway valve 26 in this first operating state.

Despite this, the coolant system 4 according to the invention permits pressure compensation between the expansion tank 50 integrated in the drive train sub-circuit 8 and the battery sub-circuit 6 by means of the pressure compensation device 52, even in this first operating state of the coolant system 4. In this regard, see FIG. 2, 7 to 13, and 14a to 14c, each of which corresponds to the first operating state, in combination. Accordingly, a second expansion tank, which would then be integrated into the battery sub-circuit 6 can be dispensed with. The pressure compensation device 52 is functionally integrated into the multiway valve 26, as explained above. The flows of the (not depicted) coolant are indicated by means of arrows 88 in FIG. 11 to 13. As is evident from the aforementioned FIG. 11 to 13 viewed in combination, the pressure-compensating connection between the recess 64 fluidically connected to the valve housing opening C and the recess 62 fluidically connected to the valve housing opening X is established in the first operating state of the coolant system 4 by means of the space formed between the inner side of the valve housing 56 and the outer side of the valve body 54, namely the end face 66 of the valve body 54, wherein the cover of the valve housing 56 is not shown in FIG. 11, analogously to FIG. 8.

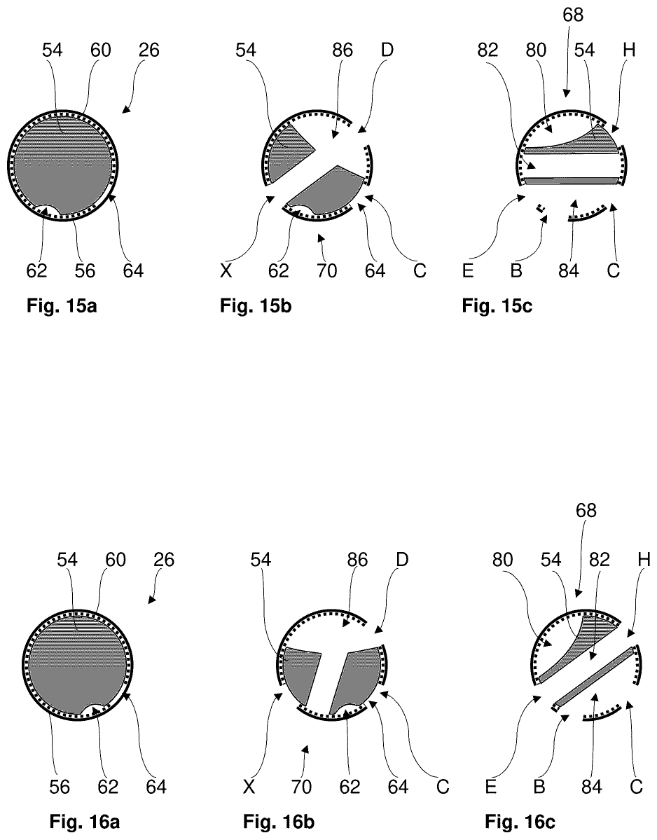

As already explained above, the pressure compensation connection is established in the first operating state by means of the pressure compensation device 52, wherein the valve housing opening X is connected fluidically to the coolant circuit 6 designed as a battery sub-circuit, and the valve housing opening C to the coolant circuit 8 designed as a drive train sub-circuit. The recess 64 in the valve seal 60 has therefore been chosen in the present example so as not to adversely affect the functionality of the multiway valve 26 with regard to the fluidic connections corresponding to the totality of the operating states of the coolant system 4. This is not mandatory, however, as long as it is ensured that the aforementioned functionality of the multiway valve is not adversely affected. As is apparent from FIG. 15a to 18c corresponding to the remaining operating states, the part of the pressure compensation device 52 on the valve body side for pressure compensation, namely the recess 62, is never connected to one of the valve housing openings B, C, D, E, H, X in the other operating states, and accordingly does not adversely affect the fluidic connections that are functionally necessary in accordance with the other operating states. Furthermore, only a single additional connection between the two coolant circuits 6, 8 is ever created by the pressure compensation device 52 for the pressure compensation, so that an unwanted circulation of the coolant between the two coolant circuits 6, 8 is prevented effectively.

On account of the invention, the functionally complex cooling system 2 for an electric vehicle having the coolant system 4 can be implemented in a manner that is simple in terms of design and manufacturing. By means of the combination according to the invention with the multiway valve 26 and the component bypass line 24, it is possible to use the component bypass line 24 for operating states of the coolant system 4 that are different from one another, since the coolant can flow through the component bypass line 24 in both fundamentally possible directions of flow. Accordingly, the number of coolant lines and valves is substantially reduced. At the same time, efficiency is increased by means of the cooling system 2, since the coolant system 4 of the cooling system 2 makes possible higher functional complexity as compared with the prior art with far fewer components. Accordingly, a multiplicity of operating states, which is to say operating modes of the cooling system 2, can be realized with the simply constructed cooling system 2, in particular the simply constructed coolant system 4.

The invention is not limited to the present example. In this regard, see, for

example, the comments relating hereto in the introductory part of the specification as well as in the description of the concrete example. In contrast to the example explained, provision can be made in other examples of the invention that, for example, the recess 64 of the valve seal 60 in accordance with the present example is replaced with a second recess on the valve body side, as long as this does not adversely affect the functionality of the multiway valve with respect to the fluidic connections corresponding to the totality of the operating states of the coolant system according to the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A coolant system for an electric vehicle to circulate a liquid coolant, the coolant system comprising:
at least two components through which the coolant is adapted to flow;
at least one valve, the at least two components, at least in a minimum of one subset, are connectable to one another in terms of coolant flow via the at least one valve and coolant lines, the at least two components being arranged in a distributed manner in at least two coolant circuits of the coolant system that are adapted to be connected and disconnected in terms of coolant flow via the at least one valve;
only a single expansion tank of the coolant system arranged in only one of the coolant circuits; and
a pressure compensator,
wherein the coolant system is designed such that the coolant circuit is essentially disconnected fluidically from at least one other coolant circuit of the at least two coolant circuits via the at least one valve, at least in one operating state of the coolant system, and, in this operating state of the coolant system, the other coolant circuit is adapted to be connected to the coolant circuit having the expansion tank in essentially only a pressure-compensating manner via a pressure compensator of the coolant system.

2. The coolant system according to claim 1, wherein the pressure compensator is designed such that, in the aforementioned operating state, in addition to the fluidic connections between the at least two coolant circuits via the pressure compensator fundamentally made possible by means via the at least one valve, and wherein only a single additional pressure-compensating connection is adapted to be established or is established between the coolant circuit having the expansion tank and the coolant circuit disconnected from this coolant circuit in the operating state.

3. The coolant system according to claim 1, wherein the pressure compensator is at least partially integrated into a valve of the at least one valve, wherein a valve body of the valve is arranged so as to be rotatable about a rotational axis of the valve in a valve housing of the valve having at least two valve housing openings of the valve, and wherein the valve housing openings are surrounded by a valve seal arranged between the valve housing and the valve body.

4. The coolant system according to claim 3, wherein the valve has at least one recess in a circumferential surface of the valve body for forming the pressure compensator, wherein the valve housing, the valve seal, and the valve body of the valve are matched to one another in design such that all fluidic connections between the at least two coolant circuits that are fundamentally made possible via the valve and correspond to a totality of the fundamentally possible operating states of the coolant system are realized in a functionally reliable manner.

5. The coolant system according to claim 4, wherein the valve has at least one recess in the valve seal for forming the pressure compensator, wherein the valve housing, the valve seal, and the valve body of the valve are matched to one another in design such that all fluidic connections between the at least two coolant circuits that are fundamentally made possible via the valve and correspond to a totality of the fundamentally possible operating states of the coolant system are realized in a functionally reliable manner.

6. The coolant system according to claim 4, wherein the recesses arranged in the valve body or the recesses arranged in the valve body and in the valve seal are connected in a pressure-compensating manner via a pressure compensation connection formed between an inner side of the valve housing and an outer side of the valve body or an end face of the valve body in the operating state of the coolant system in which the at least one other coolant circuit is essentially disconnected fluidically from the coolant circuit having the expansion tank.

7. The coolant system according to claim 3, wherein the valve with the pressure compensator at least partially integrated therein is designed as a multiway valve with two levels arranged one above the other, wherein the at least two valve housing openings in the valve housing of this multiway valve are associated in some cases with a lower level, in some cases with an upper level, and in some cases with both levels, and wherein the valve body of the multiway valve, which is arranged in the valve housing so as to be rotatable about the rotational axis, has at least one valve passage associated in each case with at least one of the lower and upper levels and disconnected fluidically from one another.

8. The coolant system according to claim 7, wherein the at least one recess in the valve body, or the at least one recess in the valve body and the at least one recess in the valve seal are designed and arranged such that the fluidic disconnection of the at least one valve passage in the lower level from the at least one valve passage in the upper level is ensured in all fluidic connections between the at least two coolant circuits that are fundamentally made possible via the multiway valve.

9. The coolant system according to claim 1, wherein the coolant system is designed such that, in the operating state of the coolant system in which the at least one other coolant circuit is essentially disconnected fluidically from the coolant circuit having the expansion tank, a back pressure acting in the coolant system via the pressure compensator acts solely from the coolant circuit having the expansion tank on the at least one other coolant circuit.

10. The coolant system according to claim 1, wherein the at least two coolant circuits are designed as a battery sub-circuit and as a drive train sub-circuit of an electric vehicle.
